(19) United States
(12) Patent Application Publication
(10) Pub. No.: US 2007/0173423 A1
(43) Pub. Date: Jul. 26, 2007

(54) METHOD AND DEVICE FOR FRAGRANCING AND FABRIC TREATMENT IN A CLOTHES DRYER

(76) Inventors: Robert Charles Vermeer, Columbus, NJ (US); Elliot M. Scherr, Plainsboro, NJ (US); Robert Langley Fuller, Asbury, NJ (US); Earle Ellis, Yorktown, VA (US); Munirhusein Adat, Plainsboro, NJ (US); Nicholas O'Leary, Pennington, NJ (US); Sandra Barvaux, London (GB)

Correspondence Address: WINSTON & STRAWN LLP;PATENT DEPARTMENT, 1700 K STREET, N.W., WASHINGTON, DC, 20006, US

(21) Appl. No.: 11/612,660

(22) Filed: Dec. 19, 2006

Related U.S. Application Data
(63) Continuation of application No. PCT/IB05/01823, filed on Jun. 28, 2005.
(60) Provisional application No. 60/584,327, filed on Jun. 29, 2004.
(60) Provisional application No. 60/588,111, filed on Jul. 14, 2004.
(60) Provisional application No. 60/591,545, filed on Jul. 26, 2004.

(51) Int. Cl. C11D 3/50

(52) U.S. Cl. 510/101; 510/302

(57) ABSTRACT

The invention relates to an improvement in a process for delivering a fabric refreshening active to a fabric. This improvement includes delivering the active to the fabric in a conventional clothes dryer such that the heat and tumbling action provided by the dryer delivers the active to the fabric while damp to thus provide refreshing properties to the fabric. The invention also relates to a product for delivering the active as noted. The active is generally applied to the fabric at a temperature in the range of 125 to 145° F., and comprises hydrogen peroxide. The refreshening active may include a fragrancing agent so that the fabric is fragranced as the refreshening agent is applied. Preferably, the refreshening active is initially placed in a container that is placed in the dryer, wherein the container does not release the agent until a desired temperature is reached.

### CROSS-REFERENCE TO RELATED APPLICATIONS

This application is a continuation of International application PCT/IB2005/001823 filed Jun. 28, 2005, which application claims the benefit of provisional applications 60/584,327 filed Jun. 29, 2004, 60/558,111 filed Jul. 14, 2004, and 60/591,545 filed Jul. 26, 2004. The entire content of each prior application is expressly incorporated herein by reference thereto.

### FIELD OF THE INVENTION

The present invention relates generally to a clothes dryer “refreshing and fragrancing” product wherein the fragrances and other actives are contained in a temperature and/or time selective dispensing device that is designed to protect the fragrance from the effects of heat and to provide improved fragrancing and softening of the fabrics This invention provides delivery of fragrances or other actives into the drier cycle under optimal conditions, resulting in a more efficient, effective, longer lasting, fragrance delivery and allowing lower use levels of the fragrance in the product to achieve the same intensity as the current state of the art technologies offer. The invention can also be applied to non-fragrance actives such as anti-static compounds, odor absorbers/controllers, anti-wrinkle treatments, fabric conditioners, sanitizers, easy ironing ingredients, fast fabric drying ingredients, insecticides and combinations thereof.

### TECHNICAL BACKGROUND AND PRIOR ART

Fragrance products designed for the clothes dryer are typically introduced at the beginning of the drying cycle. As a consequence of this early introduction, the fragrances are subject to the heat, humidity, and air flow venting conditions for the entire duration of the drying cycle.

In a clothes dryer cycle, as the clothes dry, the temperature inside the dryer rises to a maximum and then drops towards the end of the drying cycle. As a result, with current clothes dryer perfuming and/or fabric treating products it is necessary to use an excess of perfume and other actives in order to compensate for the amount of such actives that is lost through excessive evaporation and/or thermal degradation. This is typically the case when dryer sheets of current use are applied to transfer to the fabrics perfume and softening actives.

Another problem with current products for clothes dryers is that they are not dispensed at the ideal time, temperature, or humidity conditions for the optimum performance of the fragrance during the drying cycle. For instance, in a typical clothes dryer fragrance product, such as a dryer sheet, the fragrance experiences high temperatures and air flow throughout the entire drying cycle, with resulting loss of fragrance through the vent and/or prolonged thermal degradation of the fragrance. The fragrance quality is thus altered, often resulting in what is known as a “dryer heat smell” and lower fragrance intensity. Furthermore, the softener active in a dryer sheet is typically a quaternary ammonium compound and/or fatty acid type compound which can become a dominate mal-odor on dry fabric and is often described as amine like, fishy and/or rancid, fatty or greasy.

FIG. 1 presented further on clearly illustrates the temperature conditions inside a conventional clothes dryer, throughout the various phases of the drying cycle. It represents the basic heat profile during a fabric drying cycle. Two basic drying curves are represented, a curve that reflects a “ballast” drying cycle and a “towels” drying curve. Both curves were obtained using a thermocouple adhered to the dryer door, while the dryer-progressed through a timed drying cycle (without a moisture sensor). Ballast refers to an array of primarily cotton and cotton/polyester based fabrics of various weave patterns. The towels are also primarily cotton and/or cotton polyester blends, but consist of a towel type weave pattern.

The curves were developed using a computer based data logger thermocouple scheme and depict typical time/temperature conditions inside a clothes dryer. As the clothes dry, the temperature inside the dryer rises to a maximum then drops when the drying cycle ends. Four segments of the curves have been labeled for discussion; initial heat up, evaporative based drying time, finalization, and cool down (heat off). The respective conditions are summarized in the Table 1 below.

TABLE 1

| | Ballast | | Towels | |
|---|---|---|---|---|
| | Time | | Time | |
| | in Dryer | Temperature | in Dryer | Temperature |
| Dryer Phase | (minutes) | (° F.) | (minutes) | (° F.) |
| Initial Heat | 0-4 | 85-105 | 0-5 | 85-115 |
| Up | | | | |
| Drying | 4-30 | 115-130 | 4-30 | 115-137 |
| Finalization | 30-60 | 135-157 | 30-42 | 135-157 |
| Cool Down | 66-77 | 157-85 | 42-58 | 157-85 |

| | | |
|---|---|---|
| Total Cycle | 77 Minutes | 58 Minutes |
| Time | | |

Initial Heat-Up: These segments of the curves typically reflect the time and temperature achieved to begin effective drying. Essentially, a stabilization period.
Drying Time: The drying time typically reflects the time/temperature conditions of the dryer and clothing as it progresses through the cycle and as the majority of the water is evaporated from the dryer load.
Finalization Time: The finalization time reflects the time and temperature the dryer loads are exposed to while the final amount of moisture evaporates from the dryer load (note: the saw-toothed portion of the curve is a result of the on-off function of the heater cycling on and off to maintain temperature).
Cool Down: The cool down time reflects the time and temperature conditions of the dryer once the heater has been signaled to shut off.

From FIG. 1 and the Table 1, it is quite obvious to the reader that clothing (containing fragrance and/or actives) transferred from the washer to the dryer, as well as fragrance or actives added just prior to the drying cycle are subjected to the time temperature effects of the entire drying cycle. As discussed, this results have detrimental effects to the fragrance through an excessive and unnecessarily long heat history. This leads to fragrance loss through the dryer vent and thermal decomposition of the fragrance that causes fragrance loss and undesired hedonic changes of the fragrance notes. Typically, the low molecular weight fractions of the fragrance (the so-called “top” notes), often excessively volatilize prematurely and are “flashed off” and/or decomposed leaving primarily the medium molecular weight fractions (middle notes) and high molecular weight fractions of the fragrance (bottom notes) remaining. The major detrimental result is that the desired fragrance added to the clothing initially changes into an adulterated form of the original composition. Fragrance houses attempt to formulate around fragrance loss, degradation, and fragrance mutation, but it is a complex problem and the resulting fragrances and methods of delivery to fabric are not optimal.

In summary, trying to formulate around abusive dryer conditions significantly reduces the type and nature of the palette of fragrance compounds that can be used by the perfumer when compounding a perfume. The net result is a limitation in the range of fragrance types etc, which can be formulated to meet consumer needs and preferences.

It would be therefore be desirable to compensate the shortcomings of prior known articles and products for the delivery of fragrances and/or other actives such as anti-static compounds, odor absorbers/controllers, anti-wrinkle treatments, fabric conditioners, sanitizers, easy iron ingredients, fast fabric drying ingredients, insecticides and combinations thereof, in clothes dryers. More specifically, it would be advantageous to be able to automatically target the time of delivery of the active, under humidity and/or temperature conditions of the fabrics and/or dryer environment for optimal performance of the active, in particular the fragrances. Ideally, this should also be done in a cost effective manner.

Moreover, with the increase in energy costs, there has been a significant consumer trend to the use of lower temperature washing conditions, including cold water, for washing fabrics and clothes. These lower temperatures result in less effective removal of soil and stains etc., by laundry detergents. This in part is due to the reduced effectiveness, at these lower wash temperatures, of the commonly used peroxygen bleaches, such as sodium perborate and percarbonate, present in powdered laundry detergents. Expense activators such as TAED (tetraacetylethylenediamine) can be incorporated in the detergent in order to help regain some of this performance at these lower wash temperatures. However, not all of the cleaning performance loss is regained. This is especially true under cold water wash conditions, largely used to wash colored fabric loads.

It is therefore also desirable, for those consumers who then use a laundry dryer to dry these fabrics, to provide the ability to “refresh” (remove any residual lipid soils which in the presence of enzymes can create malodors, as well as oxygen bleach sensitive stains) the fabrics by means of hydrogen peroxide and then fragrance them.

In this respect, it is well known that at elevated temperatures hydrogen peroxide is very useful for providing color safe bleaching benefits to fabrics. It is normally not practical to bleach with hydrogen peroxide at temperatures below 69 degrees centigrade (140 degrees Fahrenheit). The temperature and humidity conditions (low water to fabric ratio) found during the drying process in a clothes dryer are ideal for achieving optimum performance of this type of bleach. However, in view of the fact that hydrogen peroxide may chemically decompose certain fragrance components during the high temperature bleaching phase, it is critical that the fragrance be introduced into the dryer environment after this step is completed and no more hydrogen peroxide is available.

Now, the use of peroxygen bleaches (hydrogen peroxide, sodium perborate and percarbonate) in clothes dryers has been described previously. For example, in U.S. Pat. No. 3,180,037, an aqueous hydrogen peroxide bleach solution is atomized into a clothes dryer. However, this method has the disadvantage in that the fine mist of hydrogen peroxide is apt to be swept out of the dryer by the air stream and wasted.

In U.S. Pat. No. 3,989,638 and U.S. Pat. No. 4,017,411, thickened hydrogen peroxide solutions are dispensed as a liquid from a porous pouch onto the surface of the textiles through the tumbling action within the clothes dryer. This method has two disadvantages: first, it has a tendency to distribute the hydrogen peroxide unevenly over the textiles; and second, it distributes most of the hydrogen peroxide onto the textiles at an early stage in the drying process, before the temperature of the dryer reaches the high temperature required for bleaching with hydrogen peroxide or other peroxygen bleaches. Alternatively, U.S. Pat. No. 4,130,392 tumbles the fabrics in the clothes dryer with a solid peroxygen activator, 1,3,4,6-tetra-acetyl glycouril, plus a particulate bleaching compound, such as sodium perborate or sodium percarbonate. This process has the obvious disadvantage of requiring the addition of undesirable solid particles to the clean fabrics in the dryer and can result in the buildup of such materials within the dryer or on the lint filter of the dryer. Further, such a process is even more prone to result in uneven bleaching of the textiles because of the solid particles.

Lutz in U.S. Pat. No. 4,395,261 teaches a method for bleaching damp fabrics while they are exposed to heated gases in a clothes dryer by means of hydrogen peroxide. The hydrogen peroxide is initially confined as a liquid in a container, with a hydrophobic membrane. The heat of the dryer vaporizes the hydrogen peroxide, which allows it to pass through the membrane and be delivered to the fabric from the vapor phase. They claim the ideal time to achieve the best performance to do this is when the fabrics are still damp, yet near the end of the drying cycle when the temperature within the dryer is the highest. However, it is not specified on how best (either by device and/or process) this can be done.

The prior art does not discuss how to effectively fragrance fabrics while using peroxy bleaches in the clothes dryer to obtain the refreshing benefits on fabrics. If the fragrance and the peroxy bleach are introduced together into a dryer environment, significant decomposition of the fragrance will occur because of chemical attack by this bleach. The present invention also makes it possible to address this problem and allow the combined use of a fragrance and a bleach to treat the fabrics in a clothes dryer under optimum conditions for fabric refreshing and fragrancing.

Further desirable benefits to be imparted to fabrics relate to their appearance. In particular, there is a need for compositions and processes that can be used by a consumer to provide clothes with an attractive appearance e.g. reduced wrinkles and creases and also with a fresh/pleasant fragrance, without the need to resort to time consuming ironing or expensive dry cleaning.

Technically, wrinkling is an artifact of un-relaxed stresses in the fabric fibers, which can be caused by excessive strains (creases) to the fibers (i.e. when a fiber is excessively bent/stressed, it does not fully recover to it original unbent/stressed state.). Wrinkles are also a result of fiber entanglement, electrostatic forces, friction between fibers, and inappropriate “cross-linking” which includes attachment between fibers by soils, stains, fabric treating compositions, etc.

There are currently commercially available wrinkle reduction products that also provide a fragrancing benefit to the fabrics, but which are not for use in clothes dryers. An example of one such product is DOWNY® “Wrinkle Reducer” sold by Procter & Gamble of Cincinnati, Ohio. These products, to be effective, require the dry clothes or fabrics to be dampened/wetted by the product (a high water content in the formula is required as a result) containing de-wrinkling active(s), the latter being normally delivered to the fabric via a spray bottle (pump or trigger). The consumer is then required to intervene in order to provide sufficient physical force to stretch the fabric to remove the wrinkles etc, in order to complete the process.

Compositions have been developed that are sprayed onto fabrics to improve their appearance. For example, Schwartz et al.; U.S. Pat. No. 3,674,688 discloses an aqueous alcoholic solution of a cationic surfactant, such as dialkyl dimethyl ammonium chloride, to remove wrinkles.

Kandathil, U.S. Pat. No. 3,833,393 discloses a composition containing a fabric stiffening agent, such as starch, an organic solvent with high penetrating ability and a emulsifiable wax, with optional ingredients such as a water-soluble polyalkylene glycol, a salt of a water soluble amine, and a fatty acid or an emulsified silicone that may be sprayed onto the fabric to stiffen it.

Jacobsen et al., U.S. Pat. No. 4,661,268 discloses a product and a process for removing wrinkles. The product consists essential of an alcohol-aqueous solution containing a silicone-glycol copolymer surfactant and/or a fluorinated alkyl ester surfactant together with a quaternary ammonium salt surfactant. The process consists of spraying the product onto fabric to dampen it. Church, U.S. Pat. No. 4,806,254 discloses an aqueous composition for removing wrinkle s containing a monohydric alcohol, glycerin, a nonionic surfactant and dimethyl siloxane.

A composition for fabric wrinkle reduction and shape retention is disclosed in Coffindaffer, U.S. Pat. No. 4,923,623, which includes a liquid starch having curable amino function silicones. Another fabric winkle reduction composition and method is disclosed by Agbomeirele et al., U.S. Pat. No. 5,100,566, which contains an aqueous-alcoholic solution of an anionic siliconate and glycerine. This patent also discloses a method for applying such a composition onto fabric. Vogel et al., U.S. Pat. Nos. 5,532,023 and 5,798,107 disclose the use of an aqueous spray for reducing wrinkles on treated fabric using compositions containing an effective amount of non-volatile silicone fluids, such as polydimethyl siloxane gums, together with an effective amount of film-forming polymers.

Hart et al., in U.S. Pat. No. 6,524,494 disclose compositions that provide wrinkle reduction and long lasting fragrance retention, as well as malodor reduction. This requires dampening of the fabric by the claimed compositions and stretching of the fabric by the consumer in order to achieve the de-wrinkling effect.

In all cases, this prior art requires direct consumer intervention in the process to achieve the performance benefits specified. In addition there is no reference in this prior art to the ability of the product of this invention to effectively utilize the conditions that exist in a clothes dryer during its operational cycle to possibly provide an anti-wrinkling, refreshing and perfuming benefit to fabrics without the need for consumer intervention or effort.

In the case of the clothes dryer related products that are commercially available they tend to focus on providing primarily anti-static benefits (no fabric cling) and fragancing of the fabric and are normally sold in a sheet delivery format.

In these respects, the combination of the delivery system with active(s) according to the present invention substantially departs from conventional concepts, methodologies, and designs of the prior art. This invention provides a process and formulation approach to specifically target the optimum time/temperature/humidity conditions combination in the dryer that results in the most effective and efficient usage of the active(s). Summary of the Invention The present invention now provides a new clothes dryer fragrancing, refreshing and/or anti-wrinkling product and process of application thereof that has many of the advantages of current clothes dryer products and many novel features that result in a clothes dryer product which is not anticipated, rendered obvious, suggested, or even implied by any other prior art, either alone or in any combination thereof.

The invention relates to a method to deliver actives, namely fragrances, refreshing agents and/or anti-wrinkling agents that are specifically formulated to optimally perform within a targeted temperature range, in a clothes dryer, by means of an automatic temperature and/or time responsive dispenser. The device will dispense the active under the optimum conditions for release thereof during the drying cycle.

This method to also provides a means to obtain higher residual fragrance levels at the end of the dryer cycle.

According to a specific embodiment of the invention, a device is provided for delivering a fabric refresher active(s) such as a peroxygen bleach to the fabrics in a dryer while they are still damp and to subsequently deliver a fabric substantive fragrance during the “cool down” cycle of the dryer.

The invention further provides a method for perfuming and refreshing fabrics, that comprises contacting the fabrics with the above device inside a clothes dryer, under temperature conditions such that the refreshing active and the fragrancing agent are not released into the dryer simultaneously.

Another feature of this invention is to provide a means to prolong the useful life of a clothes dryer perfuming product by delivering such a product within a closed device generally as described hereafter.

The invention also provides a method to reduce malodor in the dryer (“dryer heat smell”) due to thermal degradation of some of the fragrance ingredients, and to reduce loss of fragrance through evaporation.

The invention also provides a method for the delivery of a larger variety of actives that can be utilized in clothes dryers, alone or in combination. For instance, a clothes dryer fragrancing product can contain more volatile and/or more temperature sensitive fragrance components to enhance fragrance hedonics.

The invention also provides a means to automatically expose or deliver a clothes dryer product into a clothes dryer in a specific and targeted way.

According to another embodiment of the invention, there is provided a method and device for fragrancing fabrics and reducing fabric wrinkling, which method comprises delivering an anti-wrinkling active to the fabric in a conventional clothes dryer, while the fabric is damp to thus provide anti-wrinkling properties to the fabric. Preferably, the active is applied to the fabric at a temperature in the range of 20 to 65° C. (around 70 to 145° F.). Also, the anti-wrinkling active preferably includes a fragrancing agent so that the fabric is fragranced as the anti-wrinkling agent is applied.

The invention thus delivers an anti-wrinkling product at an appropriately targeted temperature range in the dryer that equates to the fabrics still being damp (not wet or dry). It also controls the exposure or delivery of a temperature targeted formulation to its intended environment by capitalizing on environmental events that occur inside a clothes dryer. Furthermore, the invention utilizes the tumbling action of the dryer to provide the mechanical wrinkle removing force/relaxation energy, required after the anti-wrinkle active(s) have been introduced to the “damp” fabric in the dryer, in order to de-wrinkle the fabrics.

The cost effective performance of the fragrance delivered to fabric in the dryer is enhanced by reducing overall exposure time to “hot air” venting. Furthermore, the loss and potential changes to the fragrance from the device prior to its addition to the drier are limited. Thus, a concentrated (low or no water product) anti-wrinkling active(s) product is achieved which will allow a smaller cost effective multi use product delivery system to be designed.

The invention provides a device allowing multi-use of the active in the dryer, which can be re-filled and automatically (i.e. without the user's intervention) dispenses the active substance, namely the fragrance at the optimum moment to avoid fragrance degradation. No electrical or mechanical activation is needed.

### BRIEF DESCRIPTION OF THE DRAWINGS

The accompanying drawings provide several embodiments of the device of the invention to teach implementation thereof. These drawings are illustrative only and are for the purpose of teaching how the invention can be utilized. Changes may be made in the specific construction illustrated.

The accompanying drawings use like reference characters to designate the same or similar parts throughout the several views, wherein:

FIG. 1 is a graph depicting the temperature vs. time conditions inside a clothes dryer when it is drying a load of clothes.

FIG. 2 is one example of the device of the invention related to the release of an active (e.g. fragrance sachet) into a clothes dryer when a certain temperature is met.

FIG. 3 is another example of the invention's device that can deliver an active after one or more dryer stages are completed. The drawing illustrates delivery after a final temperature cycle.

FIG. 4 shows yet another example of our invention that allows dispensing of the active when the dryer starts to cool down after a heating cycle has ended.

FIG. 5 shows a cross section view and a top view of a preferred embedment of the dispenser device comprising a recipient for the active or actives to be dispensed to the fabrics, which recipient is connected to an activation assembly comprising a thermally sensitive snap-disk

FIG. 6 shows a cross section view of the snap-disk assembly of FIG. 5 in greater detail.

FIG. 7 represents the sequence of events, from the start of the cycle up to the delivery of the active to the fabrics, via a spray thereof.

FIG. 8 shows two views of a clothes dryer comprising a device according to the invention, for dispensing an active treating substance for fabrics, said device being fastened to the door of the dryer.

FIG. 9 is a graph illustrating perfume content of differently treated dried fabrics.

### DETAILED DESCRIPTION OF THE PREFERRED EMBODIMENTS

In the present invention, the term “fabric” means articles of clothing or other household materials (sheets, towels, etc). This includes synthetic, natural, nylon, acrylic and blended articles. For example, a fabric may include materials made from cotton, linen, polyester, nylon and blends there of.

As previously indicated, the invention relates to a device for the delivery of fragrances and other actives to fabrics during the drying thereof in a clothes dryer.

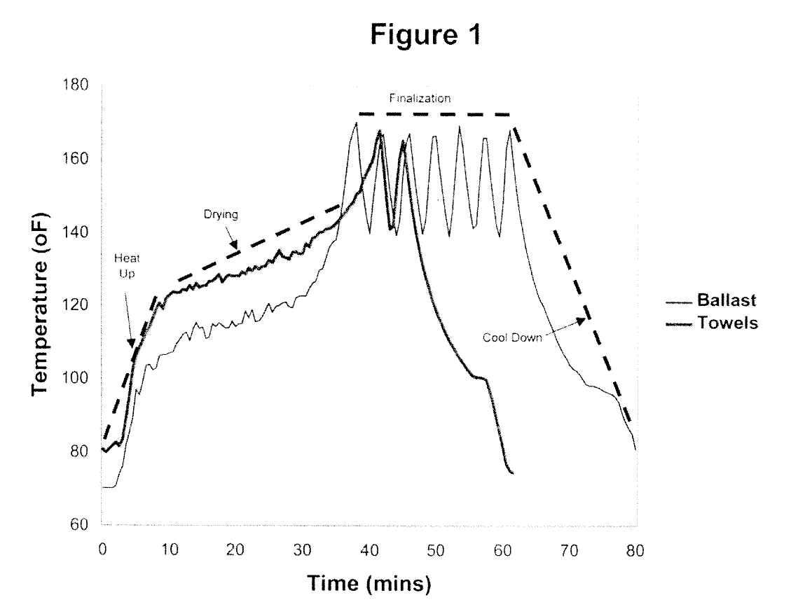

The invention further relates to a method that uses the temperature changes in the temperature profile of the drying cycle represented in FIG. 1 previously discussed, so as to deliver the actives under temperature and drying fabrics moisture content conditions such as to achieve the optimum performance of the active(s), and which comprises subjecting the fabrics within the dryer to the action of said device so as to transfer the active(s) to the fabrics at the appropriate time of the drying cycle.

Such a device, that operates at discrete temperature events/ranges and delivers or exposes the active(s), is as described in International publication number WO 03/086483 A2 or US publication 2004/0003724, the contents of which are hereby included by reference to the extent that it is necessary. It typically comprises a housing and a thermo-responsive driving means, and carries an active within a container. In the following description the terms here-below defined have the meanings indicated.

A housing is any structure that retains and holds in arrangement the components of the device.

A thermo-responsive driving means is any means that define and control the delivery temperature of the active to the dryer environment, in particular the means cited in the above-mentioned references and which are described in specific embodiments hereafter.

An active is any material or means that is intended to provide a benefit to the consumer (e.g. materials or other means that provide a fragrance benefit, reduce lint, reduce static electricity, reduce wrinkling, increase speed of drying, control the antbacterial properties and/or hygiene of the fabrics, etc.).

A fabric refreshing active is a substance or means that provides color safe bleaching type cleaning and stain removal performance under environmental conditions found in a clothes dryer, or that controls the hygiene and antibacterial properties of the fabrics treated in the clothes dryer.

A port is any opening that allows the active(s) to be released into the clothes dryer.

A shielding means is any construct that inhibits interaction of the active(s) with the intended environment prior to a targeted dispensing temperature event.

A container is any structure used to contain the active prior to dispensing or prior to exposing the active to its intended environment. The container could also form the housing of the device.

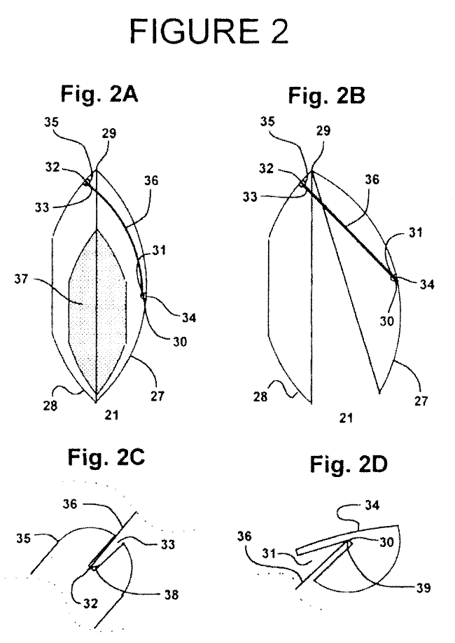

With reference to the Figures, the invention relates to one embodiment according to which there is provided a method to perfume fabrics during the drying cycle in a clothes dryer, wherein the means for delivering the fragrance active are illustrated in FIG. 2. The latter illustrates a clam shell type version of the device of the invention that delivers fragrance into the clothes dryer instantaneously (e.g. sachet) or at an increasing rate as the dryer warms up and decreasing rate as the temperature decreases. Such a behavior is obtained for example when using as the thermo-responsive means an evaporating gel.

This device can be attached to the inside of the clothes dryer door using magnetic or other attachment means and, with reference to FIGS. 2A and 2B, comprises an upper housing 27, a lower housing 28, a hinge 29, a fragrance (depicted here as a sachet) 37 and a bimetallic spring 36. The bimetallic spring 36 is normally bent when cold and straightens when the temperature rises. It can be made of any material that provides this type of behavior.

The upper housing 27 and the lower housing 28 are connected by a hinge 29 and constitute a structure hereafter referred to as the housing assembly. The hinge is comprised of a member of the group consisting of mechanical hinges, fasteners or integral plastic hinges.

FIG. 2C illustrates the bottom spring retainer assembly 35. The bottom spring retainer 35 contains a slot 33 and a bottom wedge hook 38 for securing the bottom end of the bimetallic spring 36.

FIG. 2D illustrates the top spring retainer assembly 34. The top spring retainer 34 contains a slot 31 and a top wedge hook 39 for securing the top end of bimetallic spring 36.

In FIG. 2A the device is fully closed, minimizing the exposure of the fragrance 37 to the dryer environment. The device is closed because the bimetallic spring is at a lower temperature thus forcing the housing assembly to be closed. This is the position in which the device is inserted in the clothes dryer at the beginning of the drying cycle.

FIG. 2B illustrates the device fully open, allowing delivery of the fragrance 37 into the dryer. The device in FIG. 2B develops this configuration when the dryer temperature is the warmest and causes the bimetallic spring 36 to straighten, forcing the device to open to the point where the fragrance/active drops out of the device into its intended environment 21 (e.g. inside the clothes dryer). From thereon the temperature of the dryer cools down.

Alternatively, an evaporative fragrance gel could be permanently attached to either housing of the assembly. In this case, when the dryer temperatures increase, the fragrance components increase in vapor pressure (increasing evaporation rate) thereby increasing fragrance delivery to the dryer. The opposite is true as dryer temperature decreases. The device controls this, by opening up and allowing the fragrance 37 to be increasingly exposed to the dryer as the dryer temperature rises (e.g. the vapor pressure of the fragrance rises). This allows most of the fragrance/active to be delivered when the temperature is hot, while restricting fragrance/active delivery when the temperature is cooler.

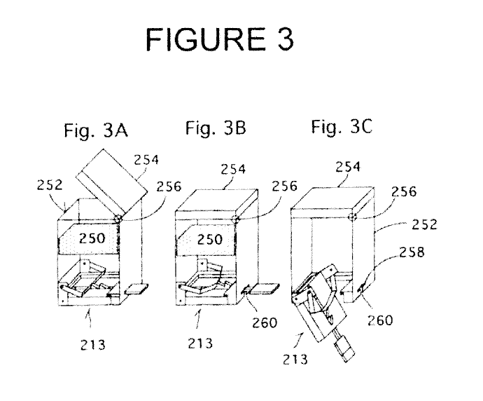

FIG. 3 shows another embodiment of the dispensing device appropriate for the objective of the invention. According to this embodiment, the fragrancing method of the invention comprises instantaneous delivery of an active when a targeted temperature is met. This device is useful in a clothes dryer for dispensing a fragrance/active before the finalization phase of the dryer cycle when a targeted temperature is met. This may be desirable if the best use of the active is when the dryer load is at a desired dampness/temperature condition for optimal performance.

The device of FIG. 3 consists of a housing 252 with manual lid 254 attached via hinge 256. The housing is outfitted with a latch retaining slot 258 and a keyway drop slot 260. Attached to the housing/lid assembly is a thermo-responsive ratchet latch assembly 213.

FIGS. 3A through 3C illustrate, in a simple manner, the basic sequence of operations. FIG. 3A illustrates the device in the cold condition—upper part of the bimetallic strip 213 is straight—with the active 250 residing in the housing 252. FIG. 3B shows the device in the hot position, at the target temperature, at the point of dumping—the bimetallic strip is bent, thus pushing the latch forward to the point of release where the width of the latch on the ratchet-latch assembly is less than the width of the keyway slot 260.

FIG. 3C illustrates the device in the dumped position, immediately after the point of release, when the active has been dispensed.

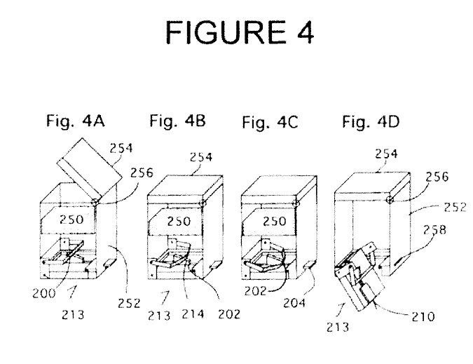

FIG. 4 represents an embodiment of the device that delivers a fragrance/active during the cool down phase of the clothes dryer cycle. This allows the active to avoid the environmental abuse present during the heat-up and finalization phase of the dryer cycle. The device of FIG. 4 comprises a thermal response ratchet assembly 213 with integrated ratchet latch assembly at 210 (see FIG. 4C). The thermally responsive ratchet assembly 213 is attached by a hinge to housing 252. A manual lid 254, which allows insertion of the active into the housing, is attached to the housing 252 via hinge 256. A latch retainer slot (FIG. 4D, 258) is integrated into the housing 252 to hold the thermal response ratchet assembly 213 in an up/closed position when the ratchet latch assembly 210 is pushed forward into the keyway slot 258.

FIGS. 4A through 4C illustrate, in a simple manner, the basic sequence of operations. FIG. 4A illustrates the device in the cold condition with active 250 loaded into the housing 252 and the bimetallic spring 200 in its cold/straight condition. FIG. 4B illustrates the device during the heat up and/or drying phase where the bimetallic spring 200 has bent forward due to the increase in temperature, thereby causing the bimetallic spring to ride down ratchet incline 214 toward ratchet catch 202. FIG. 4C shows the device when the highest dryer temperature has been met. At this temperature, the bimetallic spring falls to engage the ratchet catch 202. FIG. 4D shows the device after cooling down to a targeted temperature. In FIG. 4D, the cooler temperature caused the bimetallic spring to straighten and pull the latch 204 back into the housing to the point where the latch 204 was no longer supported by the latch retaining slot 258. With no support from the latch retaining slot 258, the thermo-responsive ratchet assembly falls to deliver the active.

In essence, FIG. 4 does a two phase operation. Phase one is an initial heat-up to maximum temperature, progressing the spring forward till it falls to engage the ratchet catch 204. Phase two is the final contraction of the spring during cool down that pulls the ratchet latch assembly 210 (at 202) backward, releasing the trap door to dispense its content 250.

The basic principles above-described to provide perfuming of the fabrics, apply in a similar manner to the delivery of other actives, but are dependent on the appropriate temperatures for dispensing the latter in the clothes dryer.

Following the embodiment of the invention according to which there is provided a method for refreshing and fragrancing the fabrics in a clothes dryer, reference is made to FIGS. 3 and 4.

In terms of “refreshing” the fabrics, the active of choice is hydrogen peroxide. This is based on the teachings of Lutz in U.S. Pat. No. 4,395,261. The hydrogen peroxide will be held, as a solution or gel, in a container/cartridge which has at least one surface covered by a hydrophobic membrane. This cartridge/container will be contained in a refillable temperature activated delivery device, which can be attached to the inside of the clothes dryer door or to any other appropriate anchoring point inside the dryer.

In this case the device would be designed to be closed at the start of the drying cycle. This would minimize/eliminate the loss of hydrogen peroxide in the dryer environment under more ideal bleaching conditions. The device is designed to open in the range of 55 to 65 C (about 135 to 145 degrees Fahrenheit), exposing the hydrogen peroxide cartridge/container to the dryer environment under optimum conditions for bleaching performance for this active.

In this respect FIG. 3 illustrates how this can be achieved by the device. The hydrogen peroxide enters the dryer environment in the vapor phase and immediately condenses onto the fabrics while they are still damp but not wet (low water to fabric ratio which is favorable in terms of the bleaching process) and at temperatures favorable to effective bleaching with this active. Specifically, the temperatures in the dryer continue to increase through the “finalization” stage (see FIG. 1), which in combination with the time (at least 30 minutes) spent by the fabrics at these higher temperatures, further enhances the bleaching performance of the hydrogen peroxide.

The fragrance is then introduced during the “cool down” sequence of the dryer. This is at a temperature below 60 degrees centigrade (140 degrees Fahrenheit), corresponding to the point when the bleaching action is finished. This also reduces fragrance overall losses through the dryer venting process, as well as minimizing hedonic changes due to the disproportional loss of high volatility “top” notes. The net outcome is improved fragrancing of the fabrics in the dryer relative to current practice. This result is again achieved by having the fragrance contained in a refillable temperature controlled delivery device, which can also be attached to the door of the dryer, as described previously.

The “fabric refreshener” and “fragrance” temperature controlled delivery systems can be functionally integrated into one overall device for attachment inside the dryer. In this case the device opens on the “cool down” cycle in the temperature range 55 to 60° C. (130 to 140 degrees Fahrenheit) in order to expose the fragrancing media to the dryer's environmental conditions

It should be noted that this delivery device would stay closed when passing through this temperature range during the heat up and drying phases of the cycle (see FIG. 1). In this respect FIG. 4 illustrates how this is achieved by the device.

Moreover, it is also clear that although the devices can be fastened to the dryer walls or door surfaces, one can also provide a clothes dryer comprising an integrated, built-in, active agent dispenser according to the invention. This can be realized in a very similar manner as that which is known in common fabric washing machines provided with mechanisms able to dispense the active at the appropriate time. This mechanism will need to be temperature triggered and be able to spray or deliver in any other manner the active in question. It will require temperature and humidity sensors to trigger release of the active at the proper time, and it will use the dryer internal electronic capabilities to release the fragrance or actives.

Following yet another embodiment of the method for treating fabrics in a clothes dryer according to the invention, there is provided a method which resorts to a device able to deliver an anti-wrinkling active ingredient, possibly in combination with a fragrance.

The fiber anti-wrinkling agents of the present invention may be natural or synthetic polymers. These fiber relaxants/lubricant agents may include, for example, cationic polyglycol ethers, silicon microemulsions, quaternized polymethyl siloxanes, polycarboxylic acids, polyvinyl pyrrolidone/dimethylamine ethyl methacrylate copolymers, ethoxylated quaternized ammonium esters, propoxylated quaternized ammonium esters and mixtures thereof. It should be noted that these ingredients are only used as examples and should not be considered limiting to the invention.

The optimum point for the introduction of the anti-wrinkling and fragrancing product in the drier cycle is at the end of the “Drying” phase and start of the “Finalization” phase (in the range of 50 to 60 degrees centigrade, 125 to 140° F.—see FIG. 1) while the fabric is damp but not wet and there remains a sufficient time period of tumbling action on the fabric during the operating cycle of the dryer to provide the required “relaxation” energy to the fabric load.

The introduction of the fragranced anti-wrinkling product in the “drying” phase of the cycle (approximately 20 to 30 minutes into the overall dryer cycle) also significantly reduces fragrance loss due to “hot” air venting when compared to the current practice of introducing a fragranced product at the beginning of the cycle. This results in higher fragrance levels on fabric at the end of the drying cycle to be achieved or alternatively a lower fragrance level (reduced product cost) in product to be used in the invention to achieve similar fabric fragrancing intensity as is achieved by current dryer products.

Separately, because the fabrics in the dryer are already “damp” when the anti-wrinkle active(s) are added, there is no need for the formulation to contribute water to wet the fabrics, as is the case for current anti-wrinkling products. This fact enables the formulation of the invention to be presented in a concentrated (significantly reduced water content) form. This has the advantage of enabling smaller cost effective delivery device formats to be used that have multi cycle dosing capabilities.

By developing a clothes dryer product that targets fragrance and anti-wrinkle active(s) release at an optimal temperature or temperature range (hence, time) allows one to make a product that provides superior anti-wrinkling and fragrance benefits to fabric than what can be achieved by current practice and art. This is achieved by leveraging the environmental/physical conditions which exist in domestic clothes dryer.

The preferred method of dispensing the product is to target release of active(s) while the clothes are damp and halfway up the heat characteristic curve. This relates to a discrete temperature event/range in the clothes dryer cycle and ensures optimum temperature specific delivery for the product in the drying process.

This invention is not limiting in scope and can be applied to provide optimal dispensing of many other active(s) forms by allowing active(s) to be dispensed in any way: continuously, discretely, at a specific rate or change in rate, at a specific temperature event, etc. This invention also allows delivery of more than one active at each active's optimal temperature and/or time.

Moreover, by specifically targeting the temperature at which the fragrance is released in the dryer, it is possible to use a much wider range of fragrance ingredients that in current methods of fabric perfuming in a clothes dryer, because the fragrance is effectively protected against thermal degradation during the phases of the drying cycle when temperature is highest. The fragrance is in fact delivered on the cool-down period of this cycle.

The invention also relates to the means for carrying out the methods of treating fabrics, i.e. the dispenser device capable of delivering the active agents, in particular fragrances, and the clothes dryers comprising such devices and allowing for treatment of the fabrics at the appropriate temperatures.

### EXAMPLES

The invention now be illustrated in an even more detailed manner by way of the following examples.

### Example 1

### An Automatic Thermosensitive Dispenser Device and a Clothes Dryer Comprising the Device

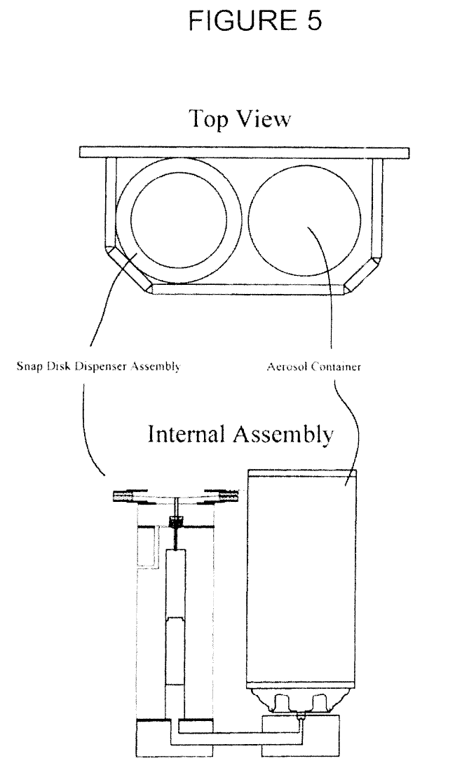

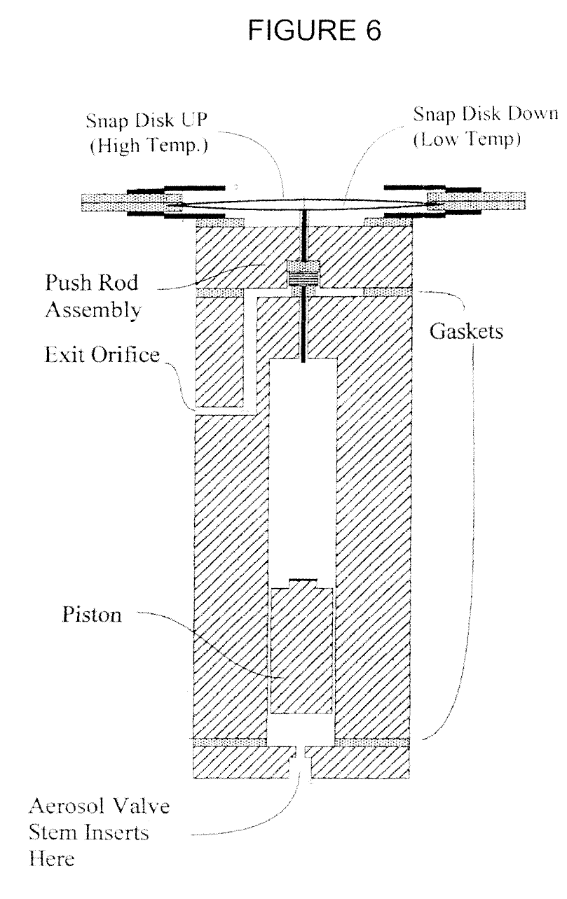

With reference to FIG. 5, a dispenser device suitable for the invention comprises a container for the active substance, namely a fragrance, antibacterial or hygiene controlling active agent, or a fabric softener or refreshing composition comprising said active agent of fragrance or antibacterial substance. The container shall typically be under internal nitrogen (or another inert gas) pressure, normally from 60 to 90 psi. The container is initially filled with the composition that it is desired to dispense onto fabrics during the drying thereof in the clothes dryer. On the left-hand side of the device assembly represented in FIG. 5, there is drawn a cross-section of an actuating thermo-responsive snap-disk assembly, represented in a more detailed manner in FIG. 6, wherein the container opening valve is directly connected to the represented mechanical assembly.

Initially, at the start of the dryer cycle, the snap-disk represented in FIG. 6 is concave. When the temperature reaches 65-75 degrees centigrade (150-170° F.) the disk snaps and assumes a convex shape thus forcing the push rod assembly down and compressing the gasket at the end of the assembly blocking the exit orifice. At this point within the chamber there is zero pressure and so the piston drops down to the bottom of the valve such that the active is loaded into the cavity. As the temperature of the dryer cools down to around 35-50 C (95-120° F.), the snap disk shape returns quickly to its original form, which is concave. So, the rod assembly and piston move up. The gasket attached to the rod assembly valve is now in the up position and so the net result is a spray pattern of active substance(s) dispensed through the now opened exit orifice onto the fabric tumbling in the dryer.

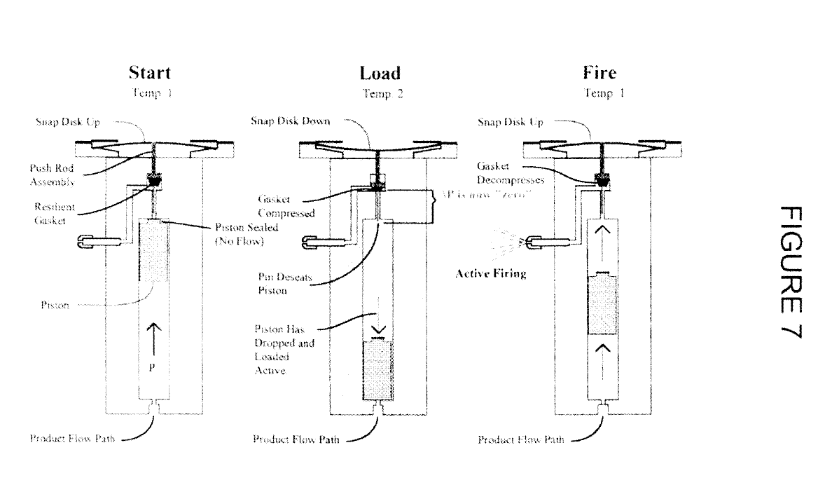

This sequence of events is represented in more detail in FIG. 7.

This unit allows for dispensing of product dosages of up to 5 ml of active composition (depending on the size of the piston and valve chamber) with excellent reproducibility. The substance can be dispensed in the form of a spray mist, stream or intermediate form thereof using a mechanical break up button, also known in the art as an actuator or spout.

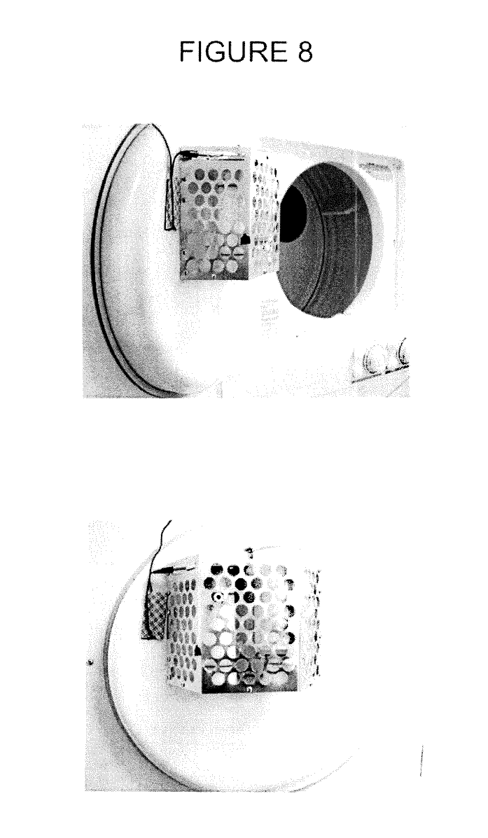

The entire unit and assembly can be seen on FIG. 8 where there is photographed a clothes dryer according to the invention comprising the device fastened to its door. Alternatively, the assembly can be incorporated in the structure of a clothes dryer according to the invention which comprises a built-in lodging for this container/dispenser assembly. Further, optionally electronic system can be incorporated.

### Example 2

### Method of Use of a Perfumed Softener Composition to Treat Fabrics in a Clothes Dryer as Described in Example 1

A perfumed softener composition, comprising the ingredients cited in Table 2 in the proportions indicated, was prepared by admixture of the ingredients. The perfume of the composition thus obtained, formed of the ingredients 3 to 15, was described as presenting a fruity/floral/green odor, with more specific peach, pineapple, green apple, jasmine, rose and green leaf nuances.

TABLE 2

| Ingredient | Name | % by Weight |
|---|---|---|
| 1 | Incrosoft TSO-90** | 24.96 |
| 2 | Isopropyl Myristate | 24.96 |
| 3 | Tetralinol | 24.49 |
| 4 | HEDIONE ® * | 7.90 |
| 5 | HABANOLIDE ® * | 6.32 |
| 6 | Geraniol | 3.16 |
| 7 | Allyl Cyclohexylpropionate | 1.58 |
| 8 | Isobomyl Acetate | 1.58 |
| 9 | Veloutone* | 1.58 |
| 10 | RHUBOFIX ® * | 1.58 |
| 11 | Cis-3-hexenyl acetate | 0.63 |
| 12 | Dihydromyrcenol | 0.47 |
| 13 | Benzyl Acetate | 0.47 |
| 14 | Galbanolene Super* | 0.16 |
| 15 | SCENTENAL ® * | 0.16 |

| | |
|---|---|
| Total | 100.00 |

*Origin: Firmenich SA, Geneva, Switzerland
**Cationic fabric softener active/anti-wrinkle agent, available commercially as methyl (dioleylamidoethyl)[polyoxyethyl]ammonium methyl sulfate (90%) and isopropanol (10%) from Coda Incorporated. The chemical structure is shown below:

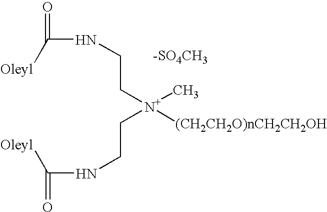

Exactly 100 ml of the above composition were placed in a 4-oz aerosol can with a standard value assembly without dip tube and actuator (button). The mount cup of the value assembly was crimped to the can and the interior thereof pressurized to 60 psi with inert nitrogen gas. The can was then placed in a dispenser device comprising a snap-disk assembly as represented in previously described FIG. 5, in the position indicated in this Figure, such that the can valve could be sprayed by means represented in this Figure, driven by the temperature activated snap disk. The whole dispenser device was then fixed to the clothes dryer door as shown in FIG. 8 and used to treat a standard load of fabrics, during the drying cycle in the dryer.

For comparison, three other fabric softening treatment alternatives were applied to three identical loads of fabrics, hereafter designated as the Comparative Fabrics 1, 2 and 3, which were treated in three conventional washing machines and dried in a conventional manner in drying machines not equipped with a dispenser as that of the present invention. The other alternatives used are indicated in Table 3 below.

TABLE 3

| | Washing Machine/Dryer | | | |
|---|---|---|---|---|
| | Invention | 1 | 2 | 3 |
| Fabrics | Invention | Comparative | Comparative | Comparative |
| | Fabrics | fabrics 1 | fabrics 2 | fabrics 3 |
| Method of | Dispenser | Dryer Sheet | Ultra Liquid | Regular |
| Delivery of | device of | | Softener | Liquid |
| Perfume and | the | | during | Softener |
| Active | invention | | washing cycle | |

The perfuming ingredients used were the same in all cases and were those ingredients 3-15 indicated above, in the same relative proportions. In the three comparative softening treatments, no additional cationic softener active, nor isopropyl myristate were used in the fabric treatment. In the case of the dryer sheet, the softening treatment was carried out in dryer, whereas with the liquids softeners, the fabrics were dried in the absence of any product. Table 4 below represents the levels of ingredients used for each wash, rinse and dryer cycle.

TABLE 4

| | | Balance of | |
|---|---|---|---|
| | Perfume | Ingredients | Total per fabric |
| Softening means | (g) | (g) | treatment (g) |
| Invention's | 1 | 1 | 2 |
| Device | | | |
| Dryer Sheet | 1 | 1 | 2 |
| Ultra Liquid | 1 | 29 | 30 |
| Softener | | | |
| Reg. Liquid | 1 | 99 | 100 |
| Softener | | | |

The fabric treatment methods were as follows.

A commercial powdered detergent (62 g) was added to four MAYTAG® type top loading washing machines. Each machine was placed on a regular cycle and allowed to fill-up with lukewarm water (80° F.). Ten cotton terry towels (1.2 kg) were added to each machine. A single wash cycle was performed, followed by a rinse and spin cycle. The wash time was 14 minutes.

The comparative liquid fabric softener samples 2 and 3, namely the Ultra Liquid softener 2 (30 g) and Regular Liquid softener 3 (100 g) were added just before the rinse cycle in machines 2 and 3 respectively. In both cases the towels were then placed in a MAYTAG® front loading dryer and allowed to dry for 60 minutes (timed dry).

The comparative dryer sheet 1 (2 g) was added to drying machine 1 fabric load and the automatic multi-load refillable dispenser device of the invention was used in the invention's dryer comprising the dispenser device attached to its door.

In the invention's dryer, just before the last 3 minutes of the cool down cycle (˜100° F.) the invention's dispenser device sprayed a mixture of perfume and fabric softener (2 g) onto the respective fabrics.

The towels were removed from all dryers, placed in plastic containers with tops and aged for one week. The towels were evaluated on blind tests by a panel of professional evaluators, both just out of the dryer and after the one week aging process.

Dynamic headspace analysis was also carried out on the one week aged dry towels for further confirmation of the amount of perfume volatiles evaporating from the aged fabrics after one week.

Sensory Evaluation Method

Each professional evaluator from a panel of 17 individuals was asked to determine, on a blind test, whether he/she could find any significant difference between the odor strength perceived on the dry towels, both just out of the dryer and after being stored in bins for 1 week. The evaluators were asked to rate the perceived odor intensity on a scale of 0 to 100 as described herebelow.
100=Extremely Strong
90=Very Strong Plus
80=Very Strong
70=Strong Plus
60=Strong
50=Medium
40=Weak Plus
30=Weak
20=Very Weak
10=Just Perceptible
0=No odor

The results of the evaluations are summarized in Table 5 below.

TABLE 5

| | Fabrics just out | |
|---|---|---|
| Softening Means | of the dryer | Fabrics after 1 week |
| Invention's dispenser device | 91 | 89 |
| Dryer sheet | 40 | 38 |
| Ultra Liquid Softener | 35 | 23 |
| Regular Liquid Softener | 28 | 22 |

It is quite clear from the above results that the fabrics treated according to the method of the invention, in a dryer comprising a dispenser device as described in the present application, were perceived by the panel as developing a far stronger odor than all the Comparative loads of fabrics, and this both just after the drying cycle and a week after the washing/drying treatment. In fact, 17 out of the 17 evaluators selected towels treated according to the invention, thus clearly showing the improvement that the latter provides in the perfuming and softening of the fabrics over those treated conventionally.

Moreover, when asked to further indicate why, apart from the perceived stronger odor, they preferred these fabrics treated according to the invention's method, all the panelists indicated that the odor of these fabrics was fresher, cleaner, more balanced, fruiter and more floral than that of the conventionally treated ones, and totally devoid of the amine/fishy odor that they could perceive in the latter.

This was also found to be the case for the dry fabrics aged for 1 week. Once again, 17 out of 17 evaluators selected the 1 week aged towels treated according to the invention. They indicated that these fabrics developed the strongest/freshest odor, when compared to those treated with a conventional dryer sheet and liquid softener means.

Headspace Analysis Evaluation

The method used in all cases was as follows.

A dry towel was placed in a 1-liter glass headspace apparatus. Headspace vapors were collected and concentrated onto adsorbent tubes (100 mg TENAX®) over 10 minutes at 40° C. using sampling pumps calibrated at 130cc/min constant airflow. A Perkin Elmer Automatic Thermal Desorption unit (ATD 400) was used to transfer the collected materials from the tubes onto a Perkin Elmer Turbomass GCMS. The ATD 400 utilized a 10 minute, 220° C. desorption step with an outlet split of 20 ml/min. The eluting compounds were split to a FID and MS detector. Chromatography was performed using a J&W DB1 column (30 m×0.32 μm×1 μm). The headspace constituents were identified using both FID retention time and mass spectra comparison to reference mass spectral libraries. The analysis was repeated on 2-3 other towels from the same wash for an average relative area count.

Table 6 summarizes the results of the analysis for each of the ingredients present in the fragrance above found on dry fabric aged week.

TABLE 6

| | | | Ultra | Reg. |
|---|---|---|---|---|
| | Invention | Dryer | Liquid | Liquid |
| Ingredient | Device | Sheet | Softener | Softener |
| Tetralinol | 24760119 | 16929 | 9691 | 56538 |
| HEDIONE ® | 263219 | 18422 | 0 | 3530 |
| HABANOLIDE ® | 347437 | 24852 | 21541 | 35716 |
| Genariol | 1614120 | 11013 | 2130 | 7430 |
| Allyl | 3556845 | 0 | 0 | 11119 |
| Cyclohexylpropionate | | | | |
| Isobornyl Acetate | 7284693 | Trace | Trace | 5842 |
| Veloutone | 7867539 | 1997 | 7618 | 12496 |
| RHUBOFIX ® | 358263 | 0 | 0 | 0 |
| Pipol Acetate | 348691 | 0 | 0 | 0 |
| Dihydromyrcenol Pur | 1392313 | 0 | 0 | 0 |
| Benzyl Acetate | 590224 | 0 | 0 | 0 |
| Galbanolene Super | 23633 | 0 | 0 | 0 |
| SCENTENAL ® | Trace | 0 | 0 | 0 |

As seen from Table 6, the automatic multi-load refillable device of the invention provides significantly more fragrance ingredients on dry fabric than the conventional softening means used to treated the fabrics, namely a dryer sheet or a liquid fabric softener. In fact closer examination of the Table 6 shows an improved presence of the so-called “top notes” on dry fabric, i.e. the types of fragrance ingredients that are typically lost when the fabrics are conventionally dried. One can in fact observe detection of a significantly greater amount of tetralinol, geraniol, isobomyl acetate, pipol acetate, dihydromyrcenol, benzyl acetate and galbanolene super present in the fabrics when the latter are treated according to the methods and process of the invention, whilst still observing improved transfer of all the other ingredients which constitute the so-called “middle” and “bottom notes” of the perfume.

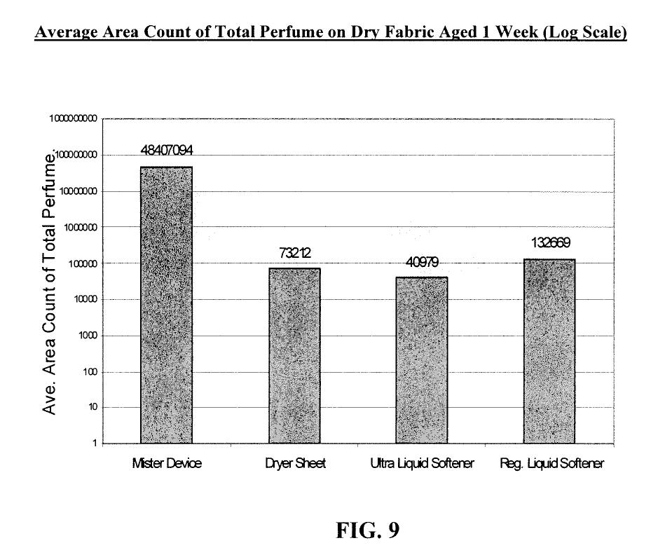

These results are further represented in the graph of FIG. 9 for the overall perfume performance in the method for treating fabrics according to the invention, via a dispenser device and clothes dryer as described above.

As seen from the graph of FIG. 9, the automatic multi-load refillable device of the invention provides significantly more total perfume on dry fabric. In fact, it delivers 661 times more perfume than a dryer sheet and about 365-1181 times more perfume than a liquid softener.

What is claimed is:

1. A process for delivering a fabric perfuming, refreshing and/or anti-wrinkling active to a fabric, which comprises delivering the active to the fabric in a clothes dryer, said dryer comprising an automatic temperature and/or time responsive dispenser capable of causing delivery of the active to the fabric to thus provide refreshing, perfuming, and/or anti-wrinkling properties to the fabric.

2. The process of claim 1 wherein the active is applied to the fabric at a temperature in the range of 20 to 65° C. (70 to 145° F.).

3. The process of claim 2 wherein the automatic dispenser comprises a thermally deformable snap-disk.

4. The process of claim 1 wherein the refreshing or anti-wrinkling active includes a fragrancing agent so that the fabric is fragranced as the refreshing or anti-wrinkling agent is applied.

5. The process of claim 1 wherein the refreshing active comprises a peroxygen bleach.

6. The process of claim 5 wherein the refreshing active is initially placed in a container arranged in the dryer, wherein the container does not release the agent until a desired temperature is reached.

7. The process of claim 1 wherein the anti-wrinkling active is initially placed in a container that is placed in the dryer, wherein the container does not release the agent until a desired temperature is reached.

8. A product for delivering a fabric perfuming, refreshing and/or anti-wrinkling active to a fabric, which comprises said active in an amount sufficient to treat the fabrics, a container for holding the active but which does not release the agent until a desired temperature is reached, such that, when the container is placed in a conventional clothes dryer and reaches a desired temperature, the container opens to deliver the active to the fabric with the heat and tumbling action provided by the dryer distributing the active to the fabric while damp to thus provide perfuming, refreshing and/or anti-wrinkling properties to the fabric.

9. The product of claim 8 wherein the desired temperature for releasing the active is in the range of 20 to 65 degrees centigrade (70 to 145° F.).

10. The product of claim 8 wherein the refreshing active includes a fragrancing agent so that the fabric is fragranced as the refreshing agent is applied.

11. The product of claim 8 wherein the refreshening active comprises hydrogen peroxide

12. A clothes dryer comprising a product according to claim 8.
